(19) United States
(12) Patent Application Publication
(10) Pub. No.: US 2025/0326386 A1
(43) Pub. Date: Oct. 23, 2025

(54) DEVICE FOR DIRECTION CONTROL AND DYNAMIC BRAKING OF ACTUATION APPLICATIONS AND PROCESS FOR IMPLEMENTING THE SAME

(71) Applicant: WHIPPANY ACTUATION SYSTEMS LLC, Whippany, NJ (US)

(72) Inventors: Shijie LIU, Whippany, NJ (US); Henry HANEK, Whippany, NJ (US)

(21) Appl. No.: 18/643,520

(22) Filed: Apr. 23, 2024

(51) Int. Cl. B60T 13/66; B60T 13/74

(52) U.S. Cl. CPC B60T 13/662; B60T 13/741

(57) ABSTRACT

Systems and methods for direction control of a motor and dynamic braking are disclosed. Systems and methods can use limit switches to not only switch the direction of motor current to provide directional control, but also to provide a path for current to flow for dynamic braking. Such current flow is produced by the motor's back electromotive force, and causes a torque to be developed which opposes motion. The torque can slow or stop a motor prior to applying a brake, limiting wear to the brake or allowing use of a positive locking brake. The limit switches and other components can be arranged to function symmetrically given different directions of current flow to allow for use of the systems and methods in forward and reverse actuation.

### CROSS-REFERENCE TO RELATED APPLICATIONS

This application claims the benefit from U.S. Provisional Application No. 63/461,395 filed on Apr. 24, 2023, which is hereby incorporated by reference in its entirety for all purposes as if fully set forth herein.

### FIELD OF THE DISCLOSURE

The disclosure relates to systems and methods for providing direction control and dynamic braking in motors. More particularly, the disclosure relates to systems and methods using limit switches for dynamically braking direct current motors and switching the direction of the direct current motors for actuating components driven by said direct current motors. Further, the disclosure relates to systems and methods using limit switches for dynamically braking brushed direct current motors and switching the direction of the brushed direct current motors for actuating components driven by the brushed direct current motors.

### BACKGROUND OF THE DISCLOSURE

A variety of techniques have been used to move actuator components within complex systems for operation of those systems. Moving such actuator components can be responsive to an actuator, which can be referred to as an “actuator output.” Examples of actuator components that must be positioned, held in place, and then repositioned repeatedly include flight surfaces in aircraft or aerospace applications. Such examples are not limited to flight surfaces, though; actuator components that are positioned, held in place, and then repeatedly positioned are found in myriad systems.

In some such actuation applications, it is beneficial (or even required) that the actuator incorporate a fail-safe brake, either of the frictional type or positive locking type. The purpose of using such a fail-safe brake is to hold the actuator output in position under load or vibration. Such frictional brakes are subject to wear, which affects the stop position accuracy (or repeatability) in many applications. The limited holding torque afforded by a friction brake could also allow the position to move under heavy vibration. Moreover, due to the associated wear of frictional brakes, such frictional brakes must receive costly periodic maintenance to replace the parts that are subject to friction in order to prevent failure.

On the other hand, to achieve the required position accuracy, a positive locking brake may be utilized. However, doing so requires that the motor stops before the brake is applied or brake damage will occur. Accordingly, an electronic controller is needed as a direct consequence of addressing this brake concern. The electronic controller is typically more complex and uses a full H-bridge or half H-bridge for operation of the motor, including directional control. This more complex circuitry requires additional EMI protection, especially for electromagnetic interference susceptibility, and specialized components for wide temperature range in certain applications. Additionally, the more complex circuitry has been found to have an increased failure rate and as such is a cause of low reliability.

Accordingly, it would be desirable to have systems and methods to efficiently and securely generate actuator outputs and utilize braking in a manner that reduces the burdens associated with wear, risk of failure, poor performance, low reliability, and/or the like.

### SUMMARY OF THE DISCLOSURE

The foregoing needs are met, to a great extent, by the disclosure, which describes systems and methods for direction control and dynamic braking of permanent magnet brushed direct current motors for actuation applications.

In one aspect, a system includes a motor configured to move an actuated component between a counterclockwise limit position and a clockwise limit position. The system in addition includes a brake configured to hold an actuated component at the counterclockwise limit position or the clockwise limit position. The system moreover includes an actuation assembly configured to operate the motor to move the actuated component between the counterclockwise limit position and the clockwise limit position. The system also includes a counterclockwise limit switch configured to determine when the actuated component is at the counterclockwise limit position. The system further includes a clockwise limit switch configured to determine when the actuated component is at the clockwise limit position. The system in addition includes the actuation assembly configured to operate the motor to dynamically brake the actuated component in response to the clockwise limit switch or the counterclockwise limit switch. The system moreover includes the actuation assembly is further configured to stop providing power to the motor, wherein stopping providing power to the motor forms a current loop for current from a counter electromotive force to flow through the motor and the brake for dynamic braking. The system also includes the actuation assembly is configured to operate the brake to be engaged thereby braking movement of the motor and/or the actuated component.

In one aspect, a process includes configuring a motor to move an actuated component between a counterclockwise limit position and a clockwise limit position. The process in addition includes configuring a brake to hold an actuated component at the counterclockwise limit position or the clockwise limit position. The process moreover includes configuring an actuation assembly to release the brake and operate the motor to move the actuated component between the counterclockwise limit position and the clockwise limit position. The process also includes configuring a counterclockwise limit switch to determine when the actuated component is at the counterclockwise limit position. The process further includes configuring a clockwise limit switch to determine when the actuated component is at the clockwise limit position. The process in addition includes configuring the actuation assembly to operate the motor to dynamically brake the actuated component in response to the clockwise limit switch or the counterclockwise limit switch. The process moreover includes configuring the actuation assembly to stop providing power to the motor, wherein stopping providing power to the motor forms a current loop for current from counter electromotive force to flow through the motor and the brake for dynamic braking. The process also includes configuring the actuation assembly to operate the brake to be engaged thereby braking movement of the motor and/or the actuated component.

In one aspect, a process includes configuring a motor to move an actuated component between a counterclockwise limit position and a clockwise limit position. The process in addition includes configuring a brake to hold an actuated component at the counterclockwise limit position or the clockwise limit position. The process moreover includes configuring an actuation assembly to release the brake and operate the motor to move the actuated component between the counterclockwise limit position and the clockwise limit position. The process also includes configuring a counterclockwise limit switch to determine when the actuated component is at the counterclockwise limit position. The process further includes configuring a clockwise limit switch to determine when the actuated component is at the clockwise limit position. The process in addition includes configuring the actuation assembly to operate the motor to dynamically brake the actuated component in response to the clockwise limit switch or the counterclockwise limit switch. The process moreover includes configuring the actuation assembly to electrically absorb kinetic energy from the system to achieve dynamic braking. The process also includes configuring the actuation assembly to operate the brake to be engaged thereby braking movement of the motor and/or the actuated component.

There has thus been outlined, rather broadly, certain aspects of the disclosure in order that the detailed description thereof may be better understood herein, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and/or to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods, and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

FIG. 1 illustrates a system configured to provide direction control and dynamic braking of a motor according to an aspect of the disclosure.

FIG. 2 illustrates further exemplary details of the system configured to provide direction control and dynamic braking of a motor according to FIG. 1.

FIG. 3 illustrates the system configured to provide direction control and dynamic braking of a motor of FIG. 2 with the motor operating in a first direction according to an aspect of the disclosure.

FIG. 4 illustrates the system configured to provide direction control and dynamic braking of a motor of FIG. 2 with the motor dynamically braking from operation in a first direction according to an aspect of the disclosure.

FIG. 5 illustrates the system configured to provide direction control and dynamic braking of a motor of FIG. 2 with the motor operating in a second direction according to an aspect of the disclosure.

FIG. 6 illustrates the system configured to provide direction control and dynamic braking of a motor of FIG. 2 with the motor dynamically braking from operation in a second direction according to an aspect of the disclosure.

FIG. 7 illustrates a controller according to the disclosure.

FIG. 8 illustrates a control process for direction control and dynamic braking of permanent magnet brushed direct current motors in actuation applications according to aspects of the disclosure.

FIG. 9 illustrates a graph of operation of the system according to aspects of the disclosure.

FIG. 10 illustrates a graph of operation of the system according to aspects of the disclosure.

### DETAILED DESCRIPTION

The disclosure will now be described with reference to the drawing figures, in which like reference numerals refer to like parts throughout. Various aspects of the disclosure advantageously provide for direction control and dynamic braking of permanent magnet brushed direct current motors in actuation applications.

To overcome the shortcomings of a traditional friction brake in actuation applications, a positive locking brake can be utilized. For example, such a brake prevents movement of the component on which the actuator acts or blocks change to the actuator output position until it is disengaged. However, using a positive locking brake requires that the motor stops before the brake is applied to prevent damage to the system, the brake, and/or the like.

To stop the motor before engaging a positive locking brake, dynamic braking as disclosed herein can be employed. Switching the direction of a direct current motor can be accomplished by switching the direction of the magnetic field produced by the stator or by switching the direction of current in the armature. With a permanent magnetic direct current brushed motor, a magnet is installed on the stationary housing called the stator, thereby fixing the direction of the stator magnetic field. With a permanent magnet, the switching of the motor rotational direction can be accomplished by changing the direction of current in the armature. Since the counter-electromotive force (“back EMF,” which is always in a direction against the input voltage) opposes the input voltage, when the input voltage is removed and a circuit loop for current is made through the motor (such as by directly shorting the motor terminals or by employing the method presented in this invention), the current will change direction and produce an opposing torque to stop the motor running. Such action is accomplished by absorbing motor kinetic energy electrically.

The systems and methods disclosed herein provide for changing the direction of the current in the armature of a motor to allow for dynamic braking to slow or stop the motor to allow for the application of a brake to maintain an actuator output. In embodiments, dynamic braking can be used to stop the motor prior to applying a positive locking brake.

By implementing the disclosures herein, dynamic braking can be achieved with components capable of use in wide temperature ranges, and embodiments further provide for protection against electromagnetic interference.

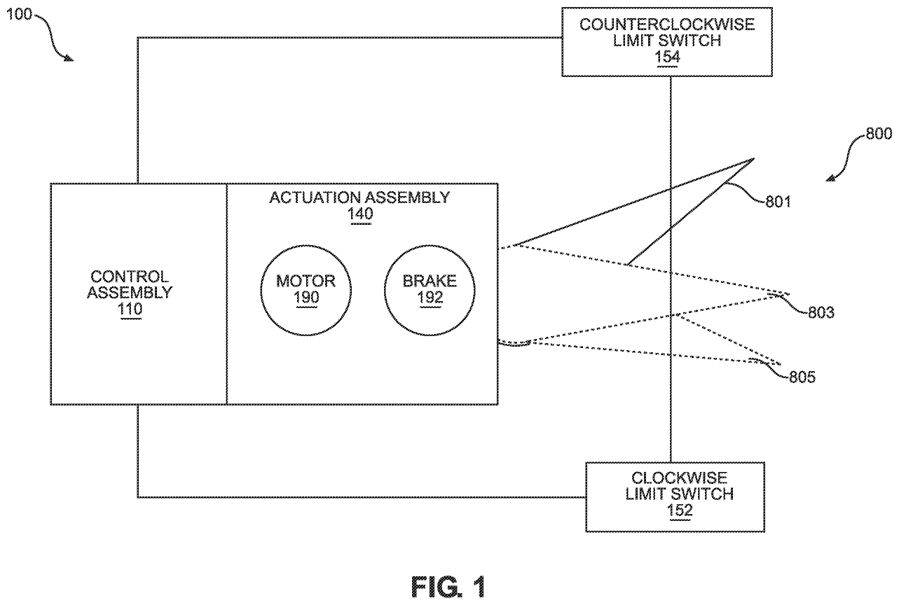

FIG. 1 illustrates a system configured to provide direction control and dynamic braking of a motor according to an aspect of the disclosure.

In particular, FIG. 1 illustrates an example of a system 100 for direction control and dynamic braking of direct current motors in actuation applications. More specifically, the system 100 may include a control assembly 110 and an actuation assembly 140. The actuation assembly 140 may include a clockwise limit switch 152, a counterclockwise limit switch 154, a motor 190, a brake 192, and/or the like.

The control assembly 110 may be configured to control the actuation assembly 140 to operate the motor 190 to move an actuated component 800 between a counterclockwise limit position 801 and a clockwise limit position 805 that includes an intermediate position 803. Further, the counterclockwise limit switch 154 may be configured to determine when the actuated component 800 is at the counterclockwise limit position 801; and the clockwise limit switch 152 may be configured to determine when the actuated component 800 is at the clockwise limit position 805.

In particular, the control assembly 110 may be configured to control the actuation assembly 140 to operate the motor 190 to move the actuated component 800 toward the counterclockwise limit position 801, such as from the clockwise limit position 805 and/or the intermediate position 803. More specifically, the control assembly 110 provides power to operate the motor 190 to move the actuated component 800 toward the counterclockwise limit position 801; and the control assembly 110 may be configured to provide power to operate the brake 192 to be disengaged. In this regard, the brake 192 may be configured to be disengaged or not braking when powered; and the brake 192 may be configured to be engaged or braking when not powered.

Further, the control assembly 110 may be configured to control the actuation assembly 140 to operate the motor 190 to dynamically brake the actuated component 800 when the actuated component 800 is at the counterclockwise limit position 801 in response to the counterclockwise limit switch 154. More specifically, the control assembly 110 may stop powering the motor 190, and the actuation assembly 140 and motor 190 may be configured to electrically absorb system kinetic energy (from back EMF) to effect dynamic braking; and the actuation assembly 140 may be configured to provide power to operate the brake 192 to be disengaged.

Thereafter, the control assembly 110 may be configured to operate the brake 192 to maintain the actuated component 800 at the counterclockwise limit position 801. More specifically, the actuation assembly 140 and motor 190 may stop electrically absorbing system kinetic energy to dynamically brake; and the actuation assembly 140 may stop providing power to operate the brake 192 and the brake 192 may be engaged thereby braking movement of the motor 190 and/or the actuated component 800.

Likewise, the control assembly 110 may be configured to control the actuation assembly 140 to operate the motor 190 to move the actuated component 800 toward the clockwise limit position 805, such as from the counterclockwise limit position 801 and/or the intermediate position 803. More specifically, the control assembly 110 may be configured to provide power to operate the motor 190 to move the actuated component 800 toward the clockwise limit position 805; and the control assembly 110 may be configured to provide power to operate the brake 192 to be disengaged. In this regard, the brake 192 may be configured to be disengaged or not braking when powered; and the brake 192 may be configured to be engaged or braking when not powered.

Further, the control assembly 110 may be configured to control the actuation assembly 140 to operate the motor 190 to dynamically brake the actuated component 800 when the actuated component 800 is at the clockwise limit position 805 in response to the clockwise limit switch 152. More specifically, the control assembly 110 may stop powering the motor 190, and the actuation assembly 140 and motor 190 may be configured to electrically absorb system kinetic energy to achieve dynamic braking; and the actuation assembly 140 may be configured to provide power to operate the brake 192 to be disengaged.

Thereafter, the control assembly 110 may be configured to operate the brake 192 to maintain the actuated component 800 at the clockwise limit position 805. More specifically, the actuation assembly 140 and motor 190 may stop electrically absorbing system kinetic energy to dynamically brake, and the actuation assembly 140 may stop providing power to operate the brake 192 and the brake 192 may be engaged and braking movement of the motor 190 and/or the actuated component 800.

Accordingly, the actuation assembly 140 may use two limit switches implemented by the clockwise limit switch 152 and the counterclockwise limit switch 154 as well as circuitry in the actuation assembly 140 to achieve the direction switching and dynamic braking of the motor 190 as further described herein. Moreover, the actuation assembly 140 may operate the brake 192 after the motor 190 has stopped.

Additionally, the actuation assembly 140 may be configured to not utilize any full H-bridge or half H-bridge circuits for operation of the motor 190. Further, the actuation assembly 140 may be implemented without additional EMI susceptibility protection and specialized components for wide temperature ranges. Accordingly, the actuation assembly 140 may have increased reliability.

In aspects, the motor 190 may be a direct current motor, a permanent magnet direct current motor, a brushed direct current motor, a permanent magnet brushed direct current motor and/or the like.

In aspects, the brake 192 may be, for example, a positive locking brake, a pin brake or a tooth brake, a brake that prevents movement of the motor 190 and/or the actuated component 800, a failsafe brake, a brake configured to be engaged and braking when unpowered, a brake configured to be disengaged and not braking when powered, a brake configured to hold the actuated component 800 in position under load, a brake configured to hold the actuated component 800 in position under heavy vibration, and/or the like. The brake 192 can be implemented through another type of failsafe brake or a plurality of failsafe brakes, and nothing in this disclosure should be read to limit the types of brakes that can be used in any embodiment or claim.

In aspects, the brake 192 may be a pin brake (not illustrated) having one or more pins and a disk having apertures configured to receive the pins. The one or more pins of the brake 192 being retracted and disengaged from the disk by a solenoid when powered; and the one or more pins of the brake 192 being extended and engaged in the apertures of the disk by springs when the solenoid is unpowered. In embodiments, the brake 192 may be a tooth brake.

In one aspect, the system 100 may be configured to actuate the actuated component 800 that includes, is connected to, and/or operates a control surface, a flight surface for an aircraft, and/or the like. In one aspect, the system 100 may be configured to actuate a flight surface for an aircraft including one or more of an aileron, an elevator, a rudder, a ruddervator, leading-edge flaps, leading-edge slats, ground spoilers, an inboard flap, an inboard aileron, an inboard aileron tab, an outboard flap, a balance tab, an outboard aileron, a flight spoiler, a trim tab, slats, air brakes, an elevator trim, a control horn, a rudder trim, an aileron trim, and/or the like. In one aspect, the actuator may be configured to actuate a component for an aircraft such as thrust reversers, weapons systems, in-flight fueling systems, tail hook arrest systems, landing gear systems, doors, hatches, and/or the like. In this regard, the system 100 is especially configured and/or beneficial to aircraft systems where reliability, weight, and/or the like are of greater importance.

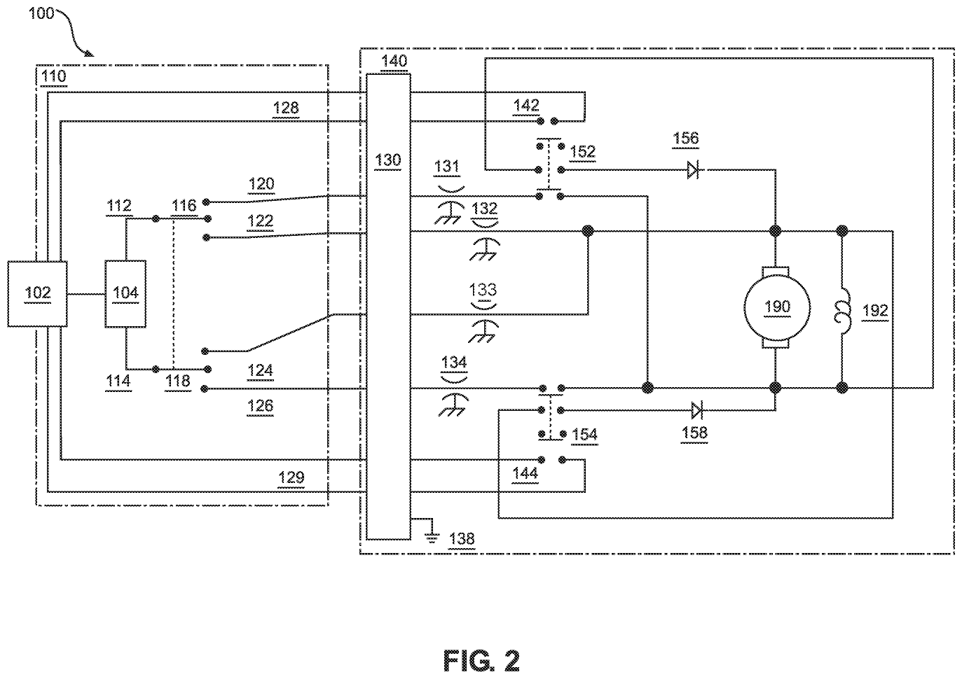

FIG. 2 illustrates further exemplary details of the system configured to provide direction control and dynamic braking of a motor according to FIG. 1.

In particular, FIG. 2 and the drawings that follow depict various paths between and among the various elements and assemblies of the system 100. These are not described exhaustively or exclusively in the drawings or this Detailed Description, and the illustrations and discussion of the system 100 in FIG. 2 and the drawings that follow only provide on example arrangement. On review of the disclosures herewith, alternative arrangements achieving equivalent or similar results will be apparent to those of ordinary skill in the art, and the particular manner of illustrating and describing the system 100 should not be interpreted as limiting or excluding such alternative arrangements. Such alternative arrangements are within the scope and spirit of this disclosure, as are alternative circuit elements or assemblies thereof for achieving equivalent or similar functional performance.

The actuation assembly 140 as shown in FIG. 2 includes the motor 190 and the brake 192. In alternative embodiments, the motor 190 and the brake 192 can be operatively coupled with but located outside the actuation assembly 140.

The control assembly 110 may include at least a direct current power supply 104 operatively coupled with a first connection 112 and a second connection 114. In embodiments, the first connection 112 is a direct current power connection and the second connection 114 is a direct current return connection. The first connection 112 connects to a first switch 116 and the second connection 114 connects to a second switch 118. In an embodiment, the direct current power connection can be a 28 volt DC power connection.

The first switch 116 may be configured to switch between a first clockwise path 120 and a first counterclockwise path 122, or may be arranged in a neutral position therebetween as shown in FIG. 2. The second switch 118 may be configured to switch between a second clockwise path 124 and a second counterclockwise path 126, or may be arranged in a neutral position therebetween as shown in FIG. 2. In aspects, the first switch 116 and/or the second switch 118 may be implemented by a switch, a solenoid switch, or the like. In particular embodiments, the first switch 116 and/or the second switch 118 can be implemented by a power switch, a power device, a transistor, a power transistor, a power module, and/or the like, which makes the system a more complex electrical device; and in such embodiments an EMI filter may be used in the circuit path of the power switch, power device, transistor, power transistor, power module, et cetera.

The control assembly 110 may also be configured to receive position indication from the clockwise limit switch 152 from a clockwise sensor circuit 128; and the control assembly 110 may also be configured to receive position indication from the counterclockwise limit switch 154 from a counterclockwise sensor circuit 129. Both of the clockwise sensor circuit 128 and the counterclockwise sensor circuit 129 may include two connections for each to complete a respective position indication circuit. In aspects, the clockwise limit switch 152 and/or the counterclockwise limit switch 154 may be implemented as double pole double throw switches. In embodiments, other sensor feedback can be received by the control assembly 110, either from the system 100 or other components operatively coupled therewith.

In embodiments, the control assembly 110 can include a controller 102. In alternative embodiments, the controller 102 can be located outside the control assembly 110, but is operatively coupled with at least the clockwise sensor circuit 128 and the counterclockwise sensor circuit 129. The controller 102 may be configured to provide control signals to the control assembly 110 to control at least the motor 190 and/or the brake 192. In embodiments, the controller 102 can be configured to energize the direct current power supply 104 and/or toggle the first switch 116 and/or the second switch 118 to clockwise, counterclockwise, or neutral positions. In embodiments, the controller 102 can be configured to energize the direct current power supply 104 and/or toggle the first switch 116 and/or the second switch 118 to clockwise, counterclockwise, or neutral positions in response to the clockwise limit switch 152, the counterclockwise limit switch 154, the clockwise sensor circuit 128, the counterclockwise sensor circuit 129, and/or the like.

The controller 102 may also be configured to receive feedback signals from the clockwise sensor circuit 128 and the counterclockwise sensor circuit 129. In aspects, the feedback signals may be configured to provide status and state information for control of the control assembly 110, the actuation assembly 140, the motor 190, the brake 192, the actuated component 800, and/or the like. In aspects, the feedback signals may provide status and state information for output to an operator or user. In embodiments, the controller 102 can be implemented in multiple subcomponents within or outside the control assembly 110, and/or feedback from the clockwise sensor circuit 128 and/or the counterclockwise sensor circuit 129 can be sent to additional or alternative components for use in control of systems (including but not limited to the system 100) and/or display to operators or users.

In aspects, the actuation assembly 140 may be configured to provide electrical power and/or electrical signals from the control assembly 110 to the motor 190, the brake 192, and/or the like. The actuation assembly 140 can be operatively coupled to the control assembly 110 using a connector 130. In alternative embodiments, the control assembly 110 and the actuation assembly 140 can be coupled through direct wiring or other means.

In embodiments like that of FIG. 2 using the connector 130, the connector 130 can include, e.g., a series of pins, sockets, and/or the like configured to provide paths for electrical power and/or signals between the control assembly 110 and the actuation assembly 140. The connector 130 can include connections for, e.g., the clockwise sensor circuit 128, the first clockwise path 120, the first counterclockwise path 122, the second clockwise path 124, the second counterclockwise path 126, the counterclockwise sensor circuit 129, and/or others. In embodiments, the connector 130 can also include a ground 138. In embodiments alternative to that illustrated in FIG. 2, the connector 130 may be disposed within the control assembly 110, or may be arranged outside both the control assembly 110 and the actuation assembly 140.

The actuation assembly 140 may optionally include one or more electromagnetic interference filters. In aspects, the actuation assembly 140 may include an electromagnetic interference filter 131, which provides protection from electromagnetic interference in some or all of the paths of system 100. In an alternative embodiment, one or more electromagnetic interference filters can be respectively disposed along a path corresponding to one of the first clockwise path 120, the first counterclockwise path 122, the second clockwise path 124, and/or the second counterclockwise path 126. Alternative embodiments can include a larger or smaller number of electromagnetic interference filters. In embodiments, electromagnetic interference filters can be included in the control assembly 110, the connector 130, and/or other components of the system 100.

In aspects, the actuation assembly 140 may also be configured to complete the circuit of the clockwise sensor circuit 128 with a clockwise feedback loop 142 when the actuated component 800 is located at the clockwise limit position 805. In particular, the clockwise sensor circuit 128 may indicate to the control assembly 110 in response to the clockwise limit switch 152 that the actuated component 800 is located at the clockwise limit position 805.

In aspects, the actuation assembly 140 may also be configured to complete the circuit of the counterclockwise sensor circuit 129 with a counterclockwise feedback loop 144 when the actuated component 800 is located at the counterclockwise limit position 801. In particular, the counterclockwise sensor circuit 129 may indicate to the control assembly 110 in response to the counterclockwise limit switch 154 that the actuated component 800 is located at the counterclockwise limit position 801.

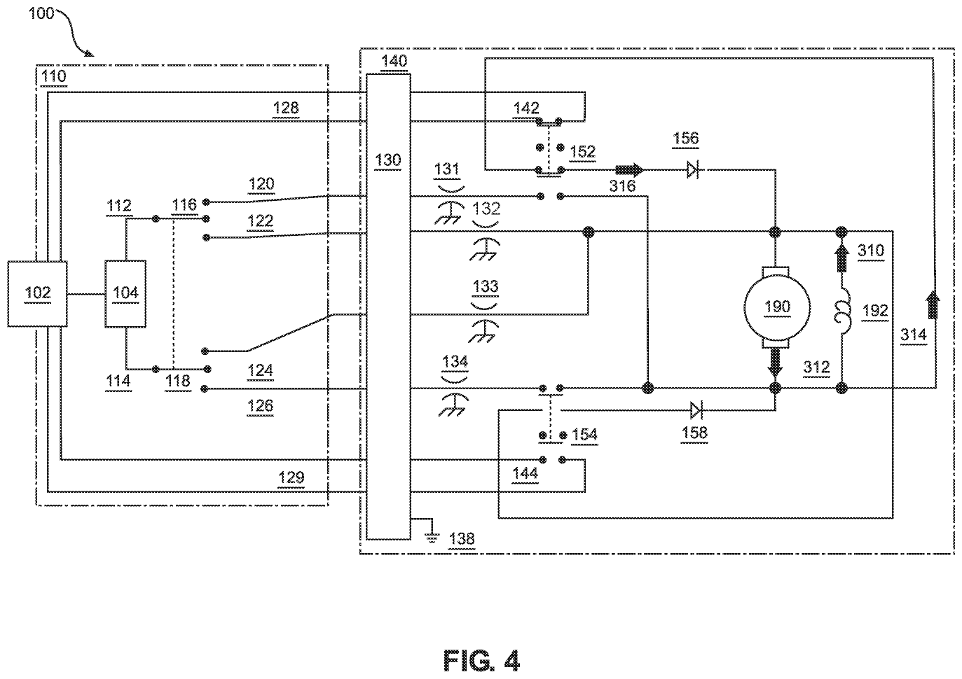

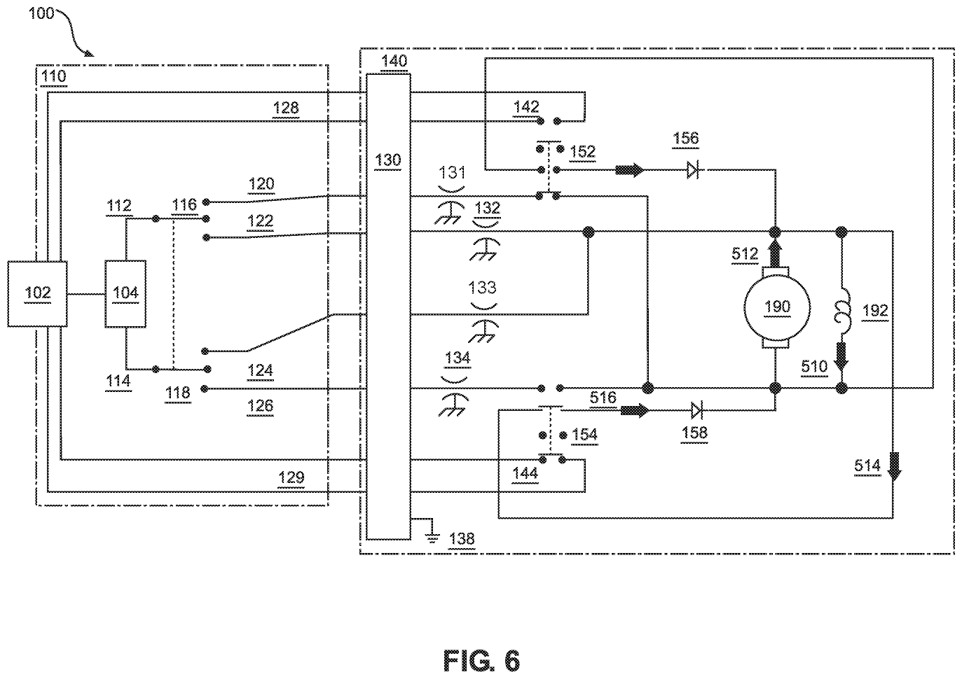

The actuation assembly 140 may also include a first diode 156 and a second diode 158. The first diode 156 and the second diode 158 may be configured to allow current to flow along their respective paths during dynamic braking as described in FIG. 4 and FIG. 6 hereafter. Otherwise, the first diode 156 and the second diode 158 may be configured to restrict current from traveling those paths.

Accordingly, the actuation assembly 140 may use two limit switches implemented by the clockwise limit switch 152 and the counterclockwise limit switch 154 as well as the first diode 156 and the second diode 158 to achieve the direction switching and dynamic braking of the motor 190 as further described herein. Accordingly, the actuation assembly 140 may be configured to not utilize any full H-bridge or half H-bridge circuits for operation of the motor 190. Further, the actuation assembly 140 may be implemented without additional EMI susceptibility protection and specialized components for wide temperature ranges. Accordingly, the actuation assembly 140 may have increased reliability.

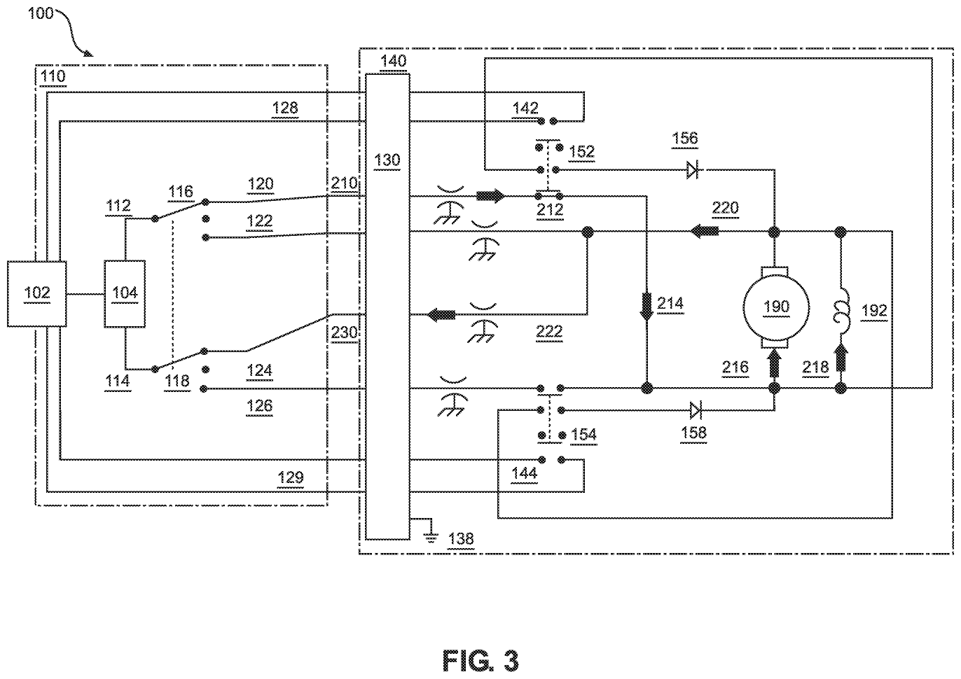

FIG. 3 illustrates the system configured to provide direction control and dynamic braking of a motor of FIG. 2 with the motor is operating in a first direction according to an aspect of the disclosure.

In particular, FIG. 3 further illustrates operation of the system 100 with the motor 190 operating in a clockwise direction. The current flow in FIG. 3 can be described as an actuation current flow through an actuation circuit path because it shows the configuration and current flow of the system 100 during actuation. While the embodiment of FIG. 3 (and other aspects herein) describe operation of the motor 190 in a clockwise direction, it is understood that the system 100 may be arranged such that the motor 190 could function in a counterclockwise direction (or realize other parameters) in this configuration without departing from the scope or spirit of the innovation.

In particular, FIG. 3 illustrates a configuration and operation of the control assembly 110 and the actuation assembly 140 when operating the motor 190 to actuate the actuated component 800 to move the actuated component 800 to the clockwise limit position 805. More specifically, the control assembly 110 may be operated such that the first switch 116 closes the circuit corresponding to the first clockwise path 120 and the second switch 118 closes the circuit corresponding to the second clockwise path 124. Additionally, the clockwise limit switch 152 may be closed as the actuated component 800 may not be located at the clockwise limit position 805.

When the system 100 is configured or set as in FIG. 3, the current flow travels from the direct current power supply 104 through the first connection 112 and the first switch 116 along the first clockwise path 120 and a path 210 to energize the actuation assembly 140. Accordingly, the control assembly 110 and/or the actuation assembly 140 may allow current to flow along the first clockwise path 120 through the connector 130 through the electromagnetic interference filter 131 (in embodiments containing the electromagnetic interference filter 131) and along to the motor 190 and the brake 192 according to the current flow depicted in FIG. 3.

In particular, current crosses the connector 130 and proceeds along a path 212, where the clockwise limit switch 152 may be closed and the current may proceed to a path 214. The path 214 forms a junction with a path 216. Current cannot flow away from the path 216 because the second switch 118 may be open in that direction. Current continues along the path 216 to the motor 190 as well as a path 218 to the brake 192. Current is prevented from flowing through other paths away from this node by the second diode 158 and the open pole of the limit switch 152.

After powering the motor 190 and the brake 192, current flows along a path 220 continuing to a path 222. The current thereafter crosses the connector 130 and proceeds along a path 230, through the second clockwise path 124 and the second switch 118, and then to a return at the second connection 114. This powers the motor 190 and/or the brake 192 in a clockwise direction in this configuration.

Accordingly, the motor 190 is powered to move the actuated component 800 toward the clockwise limit position 805; and the brake 192 is powered and disengaged to allow the actuated component 800 to move toward the clockwise limit position 805.

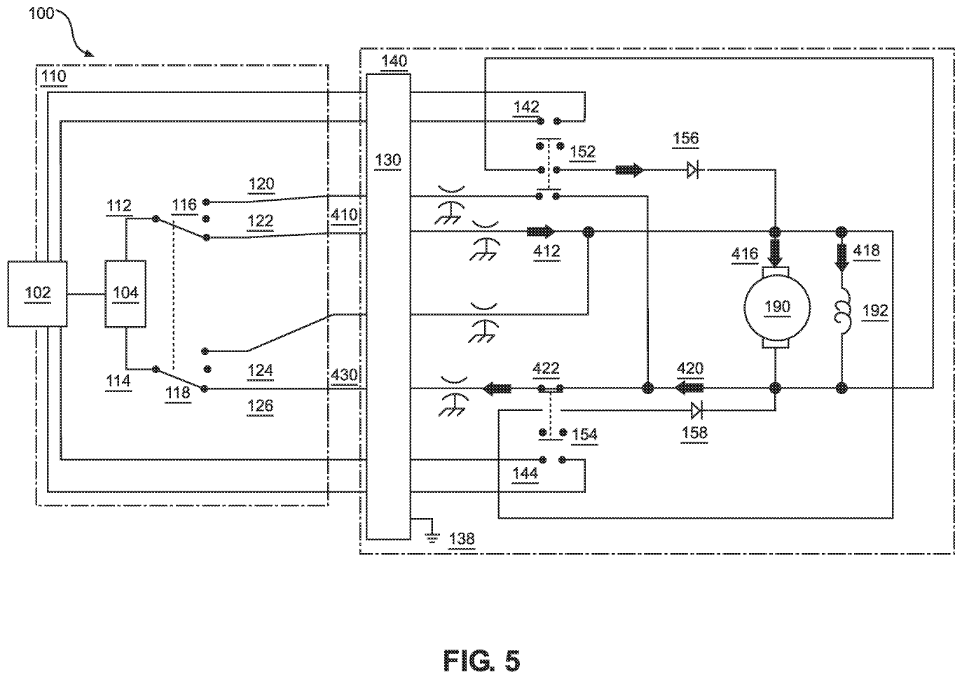

FIG. 5 illustrates the system configured to provide direction control and dynamic braking of a motor of FIG. 2 with the motor operating in a second direction according to an aspect of the disclosure.

In particular, FIG. 5 illustrates operation of the system 100 with the motor 190 operating in a counterclockwise direction. The current flow in FIG. 5 can be described as an actuation current flow through an actuation circuit path because it shows the configuration and current flow of the system during actuation. While the embodiment of FIG. 5 (and other aspects herein) describe operation of the motor 190 in a counterclockwise direction, it is understood that the system 100 may be arranged such that the motor 190 could function in a clockwise direction (or realize other parameters) in this configuration without departing from the scope or spirit of the innovation.

In particular, FIG. 5 illustrates a configuration and operation of the control assembly 110 and the actuation assembly 140 when operating the motor 190 to actuate the actuated component 800 to move the actuated component 800 to the counterclockwise limit position 801. More specifically, the control assembly 110 may be operated such that the first switch 116 closes the circuit corresponding to the first counterclockwise path 122 and the second switch 118 closes the circuit corresponding to the second counterclockwise path 126. Additionally, the counterclockwise limit switch 154 may be closed as the actuated component 800 may not be located at the counterclockwise limit position 801.

In aspects, the control assembly 110 may be configured to allow current to flow from the first connection 112 across the first switch 116 which is set to the first counterclockwise path 122 through a current path 410 proceeding across the connector 130.

Accordingly, the actuation assembly 140 may allow current to flow along the first counterclockwise path 122 through the connector 130 through the electromagnetic interference filter 131 (in embodiments containing the electromagnetic interference filter 131) and along to the motor 190 and the brake 192 according to the current flow depicted in FIG. 5.

Further, the actuation assembly 140 may be configured to allow current to flow along a path 412. Moreover, the actuation assembly 140 may be configured to allow current to flow toward the motor 190 along path 416 and the brake 192 (junctions are indicated by dots) along path 418 to power these components. Current is prevented from flowing through other paths away from this node by the first diode 156 and the open pole of the counterclockwise limit switch 154.

Further, the actuation assembly 140 may allow current to flow from the motor 190 and the brake 192 through the electromagnetic interference filter 131 (in embodiments containing the electromagnetic interference filter 131) through the connector 130 according to the current flow depicted in FIG. 5.

Further, the actuation assembly 140 may be configured to allow current to flow along a path 420 to a path 422, prevented from traveling other paths by the open lower pole of the counterclockwise limit switch 154. Further, the control assembly 110 may be configured to allow current to flow along a path 430, and returns to the direct current power supply 104 crossing the second switch 118 to the second connection 114.

Accordingly, the motor 190 is powered to move the actuated component 800 toward the counterclockwise limit position 801; and the brake 192 is powered and disengaged to allow the actuated component 800 to move toward the counterclockwise limit position 801.

FIG. 4 illustrates the system configured to provide direction control and dynamic braking of a motor of FIG. 2 with the motor dynamically braking from operation in a first direction according to an aspect of the disclosure.

In particular, FIG. 4 illustrates the arrangement of the system 100 when a dynamic braking mode is engaged from clockwise operation of the motor 190. The current flow in FIG. 4 can be described as a braking current caused by the back EMF voltage through a braking circuit path because it shows the configuration and current flow of the system 100 during dynamic braking.

As the limit of movement is reached for a component (e.g., component(s) being acted upon by the motor 190), and/or when the actuator output matches and an end-of-travel position, the limit switch 152 may be triggered. The limit switch 152 switches to close the circuit near a path 316 as well as the clockwise feedback loop 142.

More specifically, FIG. 4 illustrates a configuration and operation of the control assembly 110 and the actuation assembly 140 when operating the motor 190 to dynamically brake the actuated component 800 when the actuated component 800 is located at the clockwise limit position 805.

With the clockwise feedback loop 142 closed, the clockwise sensor circuit 128 may be configured to provide a corresponding signal which initiates control of the first switch 116 and the second switch 118. Specifically, the first switch 116 and the second switch 118 may be configured to be placed in their neutral positions, opening circuits coupled with the direct current power supply 104. A current from the brake 192 flows toward the motor 190, prevented from traveling to other paths by open circuits and/or the second diode 158.

Under such a condition, terminals of the motor 190 may be effectively shorted, and a path for regenerative current is created within the actuation assembly 140. The resultant back EMF voltage within the actuation assembly 140 generates a torque in the motor 190 in the direction opposite to motion which may dynamically brake the motor 190 and subsequently stop the motor 190.

In this regard, the actuation assembly 140 may be configured to allow current to flow along a path 310 from the brake 192 through the motor 190 in the direction opposite its clockwise operation, causing dynamic braking. Further, the actuation assembly 140 may be configured to allow current to flow from the motor 190 along a path 312 to a path 314 which feeds to the path 316 after crossing the switched closed by the clockwise limit switch 152. Further, the actuation assembly 140 may be configured to allow current to flow through the first diode 156 and back through the motor 190 as described.

Accordingly, the motor 190 is powered to dynamically brake the actuated component 800 at the counterclockwise limit position 801; and the brake 192 is powered and disengaged to allow dynamic braking of the actuated component 800 at the counterclockwise limit position 801.

Thereafter, energy within the actuation assembly 140 is dissipated by the dynamic braking of the motor 190. Accordingly, the motor 190 may no longer dynamically brake the actuated component 800. Moreover, the motor 190 may stop. Further, as the energy within the actuation assembly 140 is dissipated, the actuation assembly 140 no longer provides power to the brake 192. Accordingly, the brake 192 is engaged and brakes any subsequent movement of the motor 190 and/or the actuated component 800. Moreover, the brake 192 may hold the actuated component 800 under load and heavy vibration. In this configuration, the actuation assembly 140 may stop the motor 190 prior to engaging the brake 192, permitting use of a positive locking brake implementation of the brake 192.

FIG. 6 illustrates the system configured to provide direction control and dynamic braking of a motor of FIG. 2 with the motor dynamically braking from operation in a second direction according to an aspect of the disclosure.

In particular, FIG. 6 illustrates the arrangement of the system 100 when a dynamic braking mode is engaged from counterclockwise operation of the motor 190. The current flow in FIG. 6, which is caused by the back EMF voltage, can be described as a braking current flow through a braking circuit path because it shows the configuration and current flow of the system 100 during dynamic braking.

As the limit of movement is reached for a component (e.g., component(s) being acted upon by the motor 190), the counterclockwise limit switch 154 switches to close the circuit near a path 516 as well as the counterclockwise feedback loop 144. With the counterclockwise feedback loop 144 closed, the counterclockwise sensor circuit 129 provides a corresponding signal which initiates control of the first switch 116 and the second switch 118.

Additionally, the first switch 116 and the second switch 118 may be placed in their neutral positions by the control assembly 110, opening circuits coupled with the direct current power supply 104.

Further, the actuation assembly 140 may be configured such that a current may flow from the brake 192 along a path 510 toward the motor 190, prevented from traveling other paths by open circuits and/or the first diode 156. Further, the actuation assembly 140 may be configured such that a current may flow from the motor 190 to a path 514 to the path 516 after crossing the switched closed by the counterclockwise limit switch 154. Further, the actuation assembly 140 may be configured such that a current may flow through the second diode 158 and back through the motor 190 as described. Similar to dynamic braking from the clockwise direction, due to the symmetry of the system 100, the back EMF produced generates a torque in the opposite direction to dynamically brake the motor 190 while current flows to both the motor 190 and the brake 192.

Accordingly, a path for regenerative current is created in the actuation assembly 140 and current flows through the motor 190 in the direction opposite its counterclockwise operation along a path 512, causing dynamic braking. In particular, the motor 190 is powered to dynamically brake the actuated component 800 at the clockwise limit position 805; and the brake 192 is powered and disengaged to allow dynamic braking of the actuated component 800 at the clockwise limit position 805.

Thereafter, energy within the actuation assembly 140 is dissipated by the dynamic braking of the motor 190. Accordingly, the motor 190 may no longer dynamically brake the actuated component 800. More specifically, the motor 190 may stop.

Further, as the energy within the actuation assembly 140 is dissipated, the actuation assembly 140 no longer provides power to the brake 192. Accordingly, the brake 192 is engaged and brakes any subsequent movement of the motor 190 and/or the actuated component 800. Moreover, the brake 192 may hold the actuated component 800 under load and heavy vibration. In this configuration, the actuation assembly 140 may stop the motor 190 prior to engaging the brake 192, permitting use of a positive locking brake implementation of the brake 192.

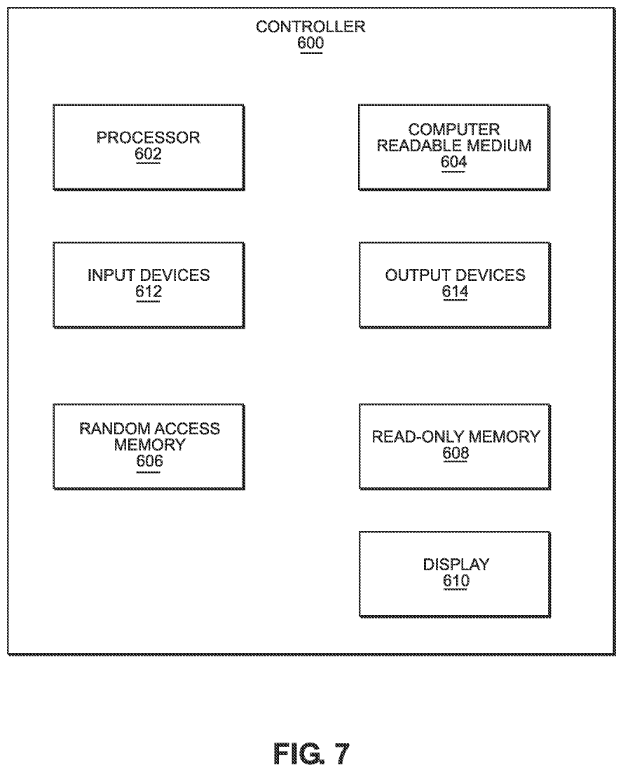

FIG. 7 illustrates a controller according to the disclosure.

In particular, FIG. 7 illustrates a controller 600 according to the disclosure. In embodiments, the controller 600 can be an embodiment of the controller 102, or a portion thereof. In embodiments, the controller 600 can be an assembly that is communicatively coupled with the controller 102.

In particular, FIG. 7 illustrates the controller 600 that may be configured to be used with the system 100 for direction control and dynamic braking of permanent magnet brushed direct current motors in actuation applications. The controller 600 may include a processor 602 configured to execute instructions stored on a computer readable medium 604. In a particular aspect, the controller 600 may be configured to control operation of, e.g., switches of the system 100. In particular, the controller 600 may control operation of the first switch 116 and the second switch 118 to control the direction of current actuating the motor 190 and direct current actuating the brake 192, and other aspects of the system 100.

In one aspect, the processor 602 implements a direction control and dynamic braking process such as a control process 700 as described below. The instructions may include various commands to control components of the system 100 for direction control and dynamic braking of permanent magnet brushed direct current motors in actuation applications. The computer readable medium 604 may be any type of memory known in the art including a non-volatile memory, such as magnetic fixed disk storage, cloud-based memory, flash memory or the like.

The processor 602 may also be in communication with other types of memory including a random access memory 606 and a read-only memory 608. The controller 600 may also include a display 610 (and/or be operatively coupled to a local or remote display included in a different system or assembly) that may show various states and indications associated with instructions executed by the processor 602. For example, the display 610 may display states of the system 100, including (but not limited to) a representation or representations of an actuation output, motor operation, a status of a brake, a current or voltage, a battery or power supply level, an operating mode, a switch position or setting, et cetera.

The controller 600 may be in communication with a plurality of input devices 612 and output devices 614. The plurality of input devices 612 may include user or pilot interface devices such as keyboard, mouse, buttons, and/or other peripheral devices to receive a user or pilot input. The user or pilot input may include instructions to change the position of a flight surface or aircraft component. Those of skill in the art will appreciate that aspects herein can be used to control other types of systems using suitable motors and brakes such as certain types of vehicles, machinery, et cetera.

The plurality of input devices 612 may also include sensors in communication with various components of the system 100 for direction control and dynamic braking of permanent magnet brushed direct current motors in actuation applications, such as position sensors, motion sensors, speed sensors, voltage sensors, current sensor, and/or other detection devices known in the art. In particular, the sensors may include sensors to determine the position, orientation, or state of various flight surfaces, movable parts, assemblies or sub-assemblies, et cetera.

The plurality of output devices 614 may include various electrical and/or mechanical control devices that may be used to control various components of the system 100, such as switches, electrical and/or electromagnetic relays, actuators, motors, brakes, or other components known in the art. In particular, the output devices 614 may control the system 100 to switch from the configuration with the motor 190 operating or dynamically braking in a clockwise direction to the configuration with the motor 190 operating or dynamically braking in a counterclockwise direction.

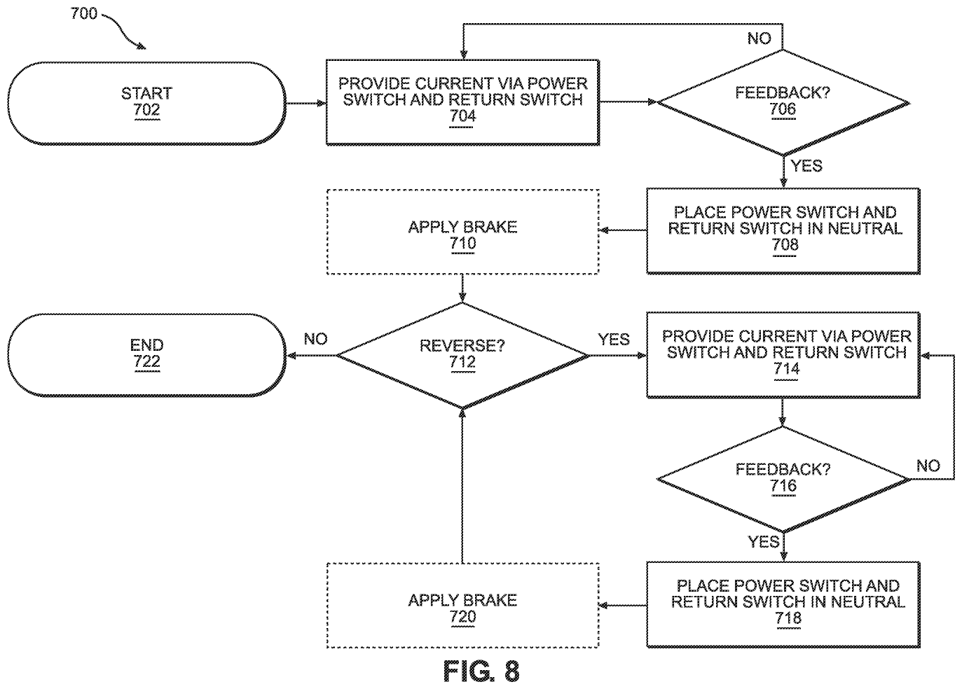

FIG. 8 illustrates a control process for direction control and dynamic braking of permanent magnet brushed direct current motors in actuation applications according to aspects of the disclosure.

In particular, FIG. 8 illustrates a control process 700 for direction control and dynamic braking of permanent magnet brushed direct current motors in actuation applications. The control process 700 may begin at a control subprocess 702 and proceeds to a control subprocess 704 where a first and second switch from the power and return connections of a power source are toggled to correspond to a first direction of operation for a motor and/or other components. The switches may be within a system or assembly arranged as depicted in the system 100 or may alternatively be arranged in an alternative apparatus configured to provide direction control and dynamic braking of a motor. In embodiments the switches each have first positions, for providing current to drive the motor in a first direction (e.g., clockwise) and second positions, for providing current to drive the motor in a second direction (e.g., counterclockwise). The first and second switches also each have third, open positions to open the circuit with the power source.

The power drives the motor and/or other components in a first direction until a limit is approached or reached, at which point a first limit switch will be triggered. The first limit switch can close a first feedback loop providing an electrical impulse or signal that is used or interpreted to control operation of the pair of switches corresponding to power and return connections of the power source.

At a control subprocess 706, the control process 700 determines whether such feedback has been received. If no such feedback has been received, the control process 700 recycles to the control subprocess 704 and the system continues to provide current.

If feedback indicating the first limit switch has tripped is received, the control process 700 proceeds to a control subprocess 708 where the power switch and the return switch are placed into a neutral, open position, breaking the circuit with the power supply. The arrangement provided for performing the control process 700 includes at least a first diode to direct the flow of current through the motor in the opposite direction of the current flow prior to placing the power and return switches into their open positions. This reverse flow of current provides dynamic braking.

At a control subprocess 710, a brake can optionally be applied. The brake may be applied after the motor (or one or more components driven by the motor) are stopped or slowed to less than a certain threshold,

At a control subprocess 712, a determination is made as to whether a reverse current (as compared with the current provided at the control subprocess 704) should be applied. The reverse current could, e.g., drive the motor in a different direction to move one or more component(s) operatively coupled with the motor in a different direction (for example, retracting to a prior position, driving to an alternate position, et cetera). If the determination at the control subprocess 712 returns negative, the control process 700 can end. Alternatively, the control process 700 could recycle to another step to continue working in the same direction or continue to await an instruction to provide current in the reverse direction.

If the determination at the control subprocess 712 returns positive, the first and second switch from the power and return connections of a power source are toggled to correspond to a second direction of operation for a motor and/or other components.

The power drives the motor and/or other components in a second direction until a limit is approached or reached, at which point a second limit switch will be triggered. The second limit switch can close a second feedback loop providing an electrical impulse or signal that is used or interpreted to control operation of the pair of switches corresponding to power and return connections of the power source. At a control subprocess 716, the control process 700 determines whether such feedback has been received. If no such feedback has been received, the control process 700 recycles to a control subprocess 714 and the system continues to provide current.

If feedback indicating the second limit switch has tripped is received, the control process 700 proceeds to control subprocess 718 where the power switch and the return switch are placed into a neutral, open position, breaking the circuit with the power supply. The arrangement provided for performing the control process 700 includes at least a second diode to direct the flow of current through the motor in the opposite direction of the current flow prior to placing the power and return switches into their open positions. This reverse flow of current provides dynamic braking.

At a control subprocess 720, a brake can optionally be applied. The brake may be applied after the motor (or one or more components driven by the motor) are stopped or slowed to less than a certain threshold.

Thereafter, the control process 700 returns to the control subprocess 712 where a determination is made as to whether the control process 700 should again reverse the flow of current. This process can proceed indefinitely, switching the current to drive the motor, components operatively coupled with the motor, and optionally a direct current brake, in opposing or multiple directions based on control instructions and feedback. Once the determination at the control subprocess 712 returns negative, the control process 700 can end at a control subprocess 722.

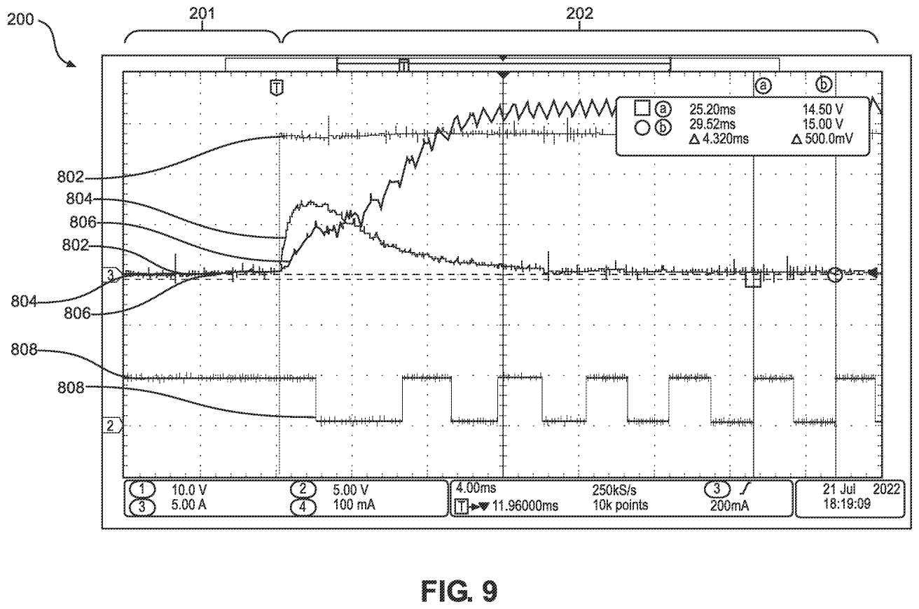

FIG. 9 illustrates a graph of operation of the system according to aspects of the disclosure.

In particular, FIG. 9 illustrates a graph of operation 200 of the system 100 according to aspects of the disclosure. Further, the graph of operation 200 illustrates a pre-operation time 201 and an operative time 202.

In this regard, the graph of operation 200 illustrates that during the pre-operation time 201 a voltage across the motor and the brake 802 is approximately zero, a current into the motor 804 is approximately zero, a current out of the brake 806 is approximately zero, and a speed of the motor 808 is approximately zero.

Accordingly, prior to operation of the system 100 during the pre-operation time 201, the motor 190 is unpowered and not moving and the brake 192 is unpowered and braking.

Further, the graph of operation 200 illustrates that during the operative time 202, the voltage across the motor and the brake 802 is above zero, the current into the motor 804 is above zero, the current out of the brake 806 is above zero, and the speed of the motor 808 (i.e., frequency of motor shaft sensor signal) is above zero.

More specifically, during the operative time 202, both the current into the motor 804 and the current out of the brake 806 begin to build up in magnitude. The slight decrease in the current out of the brake 806 after the command is produced by movement (i.e. disengagement) of the brake 192, such as a brake armature movement. Coincident with this, the motor 190 begins rotating as shown by the transitions in the speed of the motor 808. As the motor 190 speeds up, its current decreases to the steady-state value, hence the decrease in magnitude of the current into the motor 804.

Accordingly, during operation of the system 100 during the operative time 202, the motor 190 is powered and moving and the brake 192 is powered and not braking.

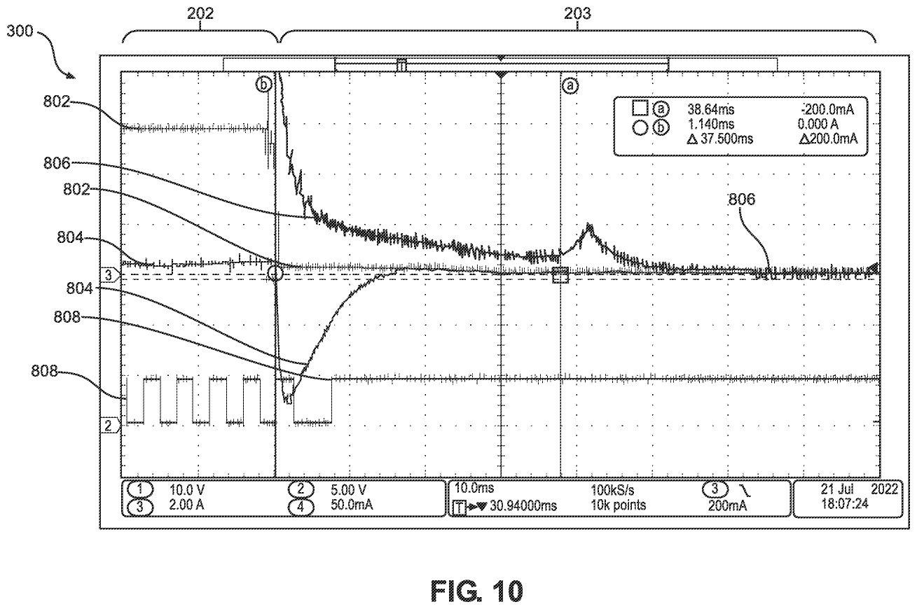

FIG. 10 illustrates a graph of operation of the system according to aspects of the disclosure.

In particular, FIG. 10 illustrates a graph of operation 300 of the system 100 according to aspects of the disclosure. Further, the graph of operation 300 illustrates the operative time 202 and a braking time 203.

Further, the graph of operation 300 illustrates that during the operative time 202, the voltage across the motor and the brake 802 is above zero, the current into the motor 804 is above zero, the current out of the brake 806 is above zero, and the speed of the motor 808 is above zero. Accordingly, during operation of the system 100 during the operative time 202, the motor 190 is powered and moving and the brake 192 is powered and not braking.

Further, the graph of operation 300 illustrates that during the braking time 203, the voltage across the motor and the brake 802 is approximately zero. Additionally, the graph of operation 300 illustrates that the current into the motor 804 is initially below zero, thus dynamically braking. Thereafter, the current into the motor 804 goes to zero and thus no longer dynamically braking.

Further, the graph of operation 300 illustrates that current out of the brake 806 is initially above zero, thus not braking. Thereafter, current out of the brake 806 goes to zero and the brake 192 is engaged and braking. Additionally, the graph of operation 300 illustrates that the speed of the motor 808 is initially moving. Thereafter, the speed of the motor 808 goes to zero due to the dynamic braking.

More specifically, during the braking time 203, a voltage across the motor 190 and brake 192 (as indicated by the change in the voltage across the motor and the brake 802) is removed by the opening of the limit switch, and motor current (the current into the motor 804) initially decreases to zero. When the limit switch closes the normally open set of contacts, a path for regenerative current is provided. At this point, the current into the motor 804 changes to a large negative value which dynamically brakes the motor 190. Shortly after this, the speed of the motor 808 shows that rotation of the motor 190 has stopped. After the start of the regenerative current, brake armature movement is observed by the positive bump in the current out of the brake 806. At this point, well after rotation of the motor 190 has stopped, the brake 192 is engaged.

Accordingly, during the braking time 203, the motor 190 is initially dynamically braked and thereafter the motor 190 stops and the brake 192 is thereafter engaged.

Accordingly, the disclosure has set forth systems and methods to efficiently and securely generate actuator outputs and utilize braking in a manner that reduces the burdens associated with wear, risk of failure, poor performance, low reliability, and/or the like.

The following are a number of nonlimiting EXAMPLES of aspects of the disclosure.

One EXAMPLE includes: a system that includes a motor configured to move an actuated component between a counterclockwise limit position and a clockwise limit position. The system in addition includes a brake configured to hold an actuated component at the counterclockwise limit position or the clockwise limit position. The system moreover includes an actuation assembly configured to operate the motor to move the actuated component between the counterclockwise limit position and the clockwise limit position. The system also includes a counterclockwise limit switch configured to determine when the actuated component is at the counterclockwise limit position. The system further includes a clockwise limit switch configured to determine when the actuated component is at the clockwise limit position. The system in addition includes the actuation assembly configured to operate the motor to dynamically brake the actuated component in response to the clockwise limit switch or the counterclockwise limit switch. The system moreover includes the actuation assembly is further configured to stop providing power to the motor to dynamically brake. The system also includes the actuation assembly is configured to operate the brake to be engaged and braking movement of the motor and/or the actuated component.

The above-noted EXAMPLE may further include any one or a combination of more than one of the following EXAMPLES:

The system of the above-noted EXAMPLE where the actuation assembly includes at least one braking circuit path to allow current to flow for dynamic braking of the motor in response to the clockwise limit switch or the counterclockwise limit switch. The system of the above-noted EXAMPLE where the actuation assembly includes a counterclockwise braking circuit path to allow current to flow for dynamic braking of the motor from operation in a counterclockwise direction in response to the counterclockwise limit switch. The system of the above-noted EXAMPLE where the actuation assembly includes a clockwise braking circuit path includes at least one diode configured to allow current to flow for dynamic braking of the motor from operation in a clockwise direction in response to the clockwise limit switch. The system of the above-noted EXAMPLE includes a control assembly includes a first switch and a second switch configured to selectively connect a direct current power supply to the actuation assembly, the motor, and the brake. The system of the above-noted EXAMPLE where the first switch and/or the second switch are implemented by a switch, a solenoid switch, a power switch, a power device, a transistor, and/or a power transistor. The system of the above-noted EXAMPLE where the actuation assembly includes a clockwise actuation circuit path for operating the motor in a clockwise direction. The system of the above-noted EXAMPLE where control assembly controls the first switch and the second switch to selectively connect the direct current power supply to the clockwise actuation circuit path for operating the motor in a clockwise direction. The system of the above-noted EXAMPLE where the actuation assembly includes a clockwise braking circuit path includes at least one diode configured to allow current to flow for dynamic braking of the motor from operation in the clockwise direction. The system of the above-noted EXAMPLE where the actuation assembly includes a counterclockwise actuation circuit path for operating the motor in a counterclockwise direction. The system of the above-noted EXAMPLE where control assembly controls the first switch and the second switch to selectively connect the direct current power supply to the counterclockwise actuation circuit path for operating the motor in a counterclockwise direction. The system of the above-noted EXAMPLE where the actuation assembly includes a counterclockwise braking circuit path includes at least one diode configured to allow current to flow for dynamic braking of the motor from operation in the counterclockwise direction. The system of the above-noted EXAMPLE where the actuation assembly includes at least one diode configured to allow current to flow for dynamic braking of the motor. The system of the above-noted EXAMPLE where the motor includes a brushed direct current motor. The system of the above-noted EXAMPLE where the brake includes a positive locking brake. The system of the above-noted EXAMPLE where the brake includes a pin brake.

One EXAMPLE includes: a process that includes configuring a motor to move an actuated component between a counterclockwise limit position and a clockwise limit position. The process in addition includes configuring a brake to hold an actuated component at the counterclockwise limit position or the clockwise limit position. The process moreover includes configuring an actuation assembly to operate the motor to move the actuated component between the counterclockwise limit position and the clockwise limit position. The process also includes configuring a counterclockwise limit switch to determine when the actuated component is at the counterclockwise limit position. The process further includes configuring a clockwise limit switch to determine when the actuated component is at the clockwise limit position. The process in addition includes configuring the actuation assembly to operate the motor to dynamically brake the actuated component in response to the clockwise limit switch or the counterclockwise limit switch. The process moreover includes configuring the actuation assembly to stop providing power to the motor to dynamically brake. The process also includes configuring the actuation assembly to operate the brake to be engaged and braking movement of the motor and/or the actuated component.

The above-noted EXAMPLE may further include any one or a combination of more than one of the following EXAMPLES:

The process of the above-noted EXAMPLE where the actuation assembly includes at least one braking circuit path to allow current to flow for dynamic braking of the motor in response to the clockwise limit switch or the counterclockwise limit switch. The process of the above-noted EXAMPLE where the actuation assembly includes a counterclockwise braking circuit path to allow current to flow for dynamic braking of the motor from operation in a counterclockwise direction in response to the counterclockwise limit switch. The process of the above-noted EXAMPLE where the actuation assembly includes a clockwise braking circuit path includes at least one diode configured to allow current to flow for dynamic braking of the motor from operation in a clockwise direction in response to the clockwise limit switch. The process of the above-noted EXAMPLE includes implementing a control assembly includes a first switch and a second switch configured to selectively connect a direct current power supply to the actuation assembly, the motor, and the brake. The process of the above-noted EXAMPLE where the first switch and/or the second switch are implemented by a switch, a solenoid switch, a power switch, a power device, a transistor, and/or a power transistor. The process of the above-noted EXAMPLE where the actuation assembly includes a clockwise actuation circuit path for operating the motor in a clockwise direction. The process of the above-noted EXAMPLE where control assembly controls the first switch and the second switch to selectively connect the direct current power supply to the clockwise actuation circuit path for operating the motor in a clockwise direction. The process of the above-noted EXAMPLE where the actuation assembly includes a clockwise braking circuit path includes at least one diode configured to allow current to flow for dynamic braking of the motor from operation in the clockwise direction. The process of the above-noted EXAMPLE where the actuation assembly includes a counterclockwise actuation circuit path for operating the motor in a counterclockwise direction. The process of the above-noted EXAMPLE where control assembly controls the first switch and the second switch to selectively connect the direct current power supply to the counterclockwise actuation circuit path for operating the motor in a counterclockwise direction. The process of the above-noted EXAMPLE where the actuation assembly includes a counterclockwise braking circuit path includes at least one diode configured to allow current to flow for dynamic braking of the motor from operation in the counterclockwise direction. The process of the above-noted EXAMPLE where the actuation assembly includes at least one diode configured to allow current to flow for dynamic braking of the motor. The process of the above-noted EXAMPLE where the motor includes a brushed direct current motor. The process of the above-noted EXAMPLE where the brake includes a positive locking brake. The process of the above-noted EXAMPLE where the brake includes a pin brake.

The systems and methods disclosed herein can be implemented within flight surface control systems or other actuation systems using a direct current motor or similar actuator that can be dynamically braked by switching the current direction. The design is more cost effective than many alternatives and avoids the limitations of other types of actuators or actuator controls and brakes that require greater maintenance and experience greater wear. The design can be implemented on lightweight and smaller envelope demands than prior systems, and can be used in applications requiring full redundant linear actuation.

Further in accordance with various aspects of the disclosure, the methods described herein are intended for operation with dedicated hardware implementations including, application specific integrated circuits (ASIC), programmable logic arrays, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

The many features and advantages of the disclosure are apparent from the detailed specification, and, thus, it is intended by the appended claims to cover all such features and advantages of the disclosure, which fall within the true spirit, and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A system for direction control and dynamic braking of a motor for an actuator, the system comprising:
a motor configured to move an actuated component between a counterclockwise limit position and a clockwise limit position;
a brake configured to hold an actuated component at the counterclockwise limit position or the clockwise limit position;
an actuation assembly configured to operate the motor to move the actuated component between the counterclockwise limit position and the clockwise limit position;
a counterclockwise limit switch configured to determine when the actuated component is at the counterclockwise limit position;
a clockwise limit switch configured to determine when the actuated component is at the clockwise limit position;
the actuation assembly configured to operate the motor to dynamically brake the actuated component in response to the clockwise limit switch or the counterclockwise limit switch;
the actuation assembly is further configured to stop providing power to the motor, wherein stopping providing power to the motor forms a current loop for current from counter electromotive force to flow through the motor and the brake for dynamic braking; and
the actuation assembly is configured to operate the brake to be engaged thereby braking movement of the motor and/or the actuated component.

2. The system for direction control and dynamic braking of a motor for an actuator of claim 1 wherein the actuation assembly comprises at least one braking circuit path to allow current to flow for dynamic braking of the motor in response to the clockwise limit switch or the counterclockwise limit switch.

3. The system for direction control and dynamic braking of a motor for an actuator of claim 1 wherein the actuation assembly comprises a counterclockwise braking circuit path to allow current to flow for dynamic braking of the motor from operation in a counterclockwise direction in response to the counterclockwise limit switch.

4. The system for direction control and dynamic braking of a motor for an actuator of claim 1 wherein the actuation assembly comprises a clockwise braking circuit path comprising at least one diode configured to allow current to flow for dynamic braking of the motor from operation in a clockwise direction in response to the clockwise limit switch.

5. The system for direction control and dynamic braking of a motor for an actuator of claim 1 further comprising a control assembly comprising a first switch and a second switch configured to selectively connect a direct current power supply to the actuation assembly, the motor, and the brake.

6. The system for direction control and dynamic braking of a motor for an actuator of claim 5 wherein the first switch and/or the second switch are implemented by a switch, a solenoid switch, a power switch, and/or a power device.

7. The system for direction control and dynamic braking of a motor for an actuator of claim 5 comprising at least one electromagnetic interference filter, wherein the first switch and/or the second switch are implemented by a transistor, and/or a power transistor, and wherein the transistor and/or the power transistor are in a circuit path with the electromagnetic interference filter.

8. The system for direction control and dynamic braking of a motor for an actuator of claim 5 wherein the actuation assembly comprises at least one diode configured to allow current to flow for dynamic braking of the motor.

9. The system for direction control and dynamic braking of a motor for an actuator of claim 5 wherein the actuation assembly comprises a clockwise actuation circuit path for operating the motor in a clockwise direction.

10. The system for direction control and dynamic braking of a motor for an actuator of claim 9 wherein control assembly controls the first switch and the second switch to selectively connect the direct current power supply to the clockwise actuation circuit path for operating the motor in a clockwise direction.

11. The system for direction control and dynamic braking of a motor for an actuator of claim 9 wherein the actuation assembly comprises a clockwise braking circuit path comprising at least one diode configured to allow current to flow for dynamic braking of the motor from operation in the clockwise direction.

12. The system for direction control and dynamic braking of a motor for an actuator of claim 5 wherein the actuation assembly comprises a counterclockwise actuation circuit path for operating the motor in a counterclockwise direction.

13. The system for direction control and dynamic braking of a motor for an actuator of claim 12 wherein control assembly controls the first switch and the second switch to selectively connect the direct current power supply to the counterclockwise actuation circuit path for operating the motor in a counterclockwise direction.

14. The system for direction control and dynamic braking of a motor for an actuator of claim 12 wherein the actuation assembly comprises a counterclockwise braking circuit path comprising at least one diode configured to allow current to flow for dynamic braking of the motor from operation in the counterclockwise direction.

15. The system for direction control and dynamic braking of a motor for an actuator of claim 1 wherein the motor comprises a PM brushed direct current motor.

16. The system for direction control and dynamic braking of a motor for an actuator of claim 1 wherein the brake comprises a positive locking brake or a frictional brake.

17. The system for direction control and dynamic braking of a motor for an actuator of claim 1 wherein the brake comprises a pin brake or a tooth brake.

18. A process of implementing a system for direction control and dynamic braking of a motor for an actuator, the system comprising:
configuring a motor to move an actuated component between a counterclockwise limit position and a clockwise limit position;
configuring a brake to hold an actuated component at the counterclockwise limit position or the clockwise limit position;
configuring an actuation assembly to operate the motor to move the actuated component between the counterclockwise limit position and the clockwise limit position;
configuring a counterclockwise limit switch to determine when the actuated component is at the counterclockwise limit position;
configuring a clockwise limit switch to determine when the actuated component is at the clockwise limit position;
configuring the actuation assembly to operate the motor to dynamically brake the actuated component in response to the clockwise limit switch or the counterclockwise limit switch;
configuring the actuation assembly to stop providing power to the motor, wherein stopping providing power to the motor forms a current loop for current from counter electromotive force to flow through the motor and the brake for dynamic braking; and
configuring the actuation assembly to operate the brake to be engaged thereby braking movement of the motor and/or the actuated component.

19. The process of implementing a system for direction control and dynamic braking of a motor for an actuator of claim 18 wherein the actuation assembly comprises at least one braking circuit path to allow current to flow for dynamic braking of the motor in response to the clockwise limit switch or the counterclockwise limit switch.

20. The process of implementing a system for direction control and dynamic braking of a motor for an actuator of claim 18 wherein the actuation assembly comprises a counterclockwise braking circuit path to allow current to flow for dynamic braking of the motor from operation in a counterclockwise direction in response to the counterclockwise limit switch.

21. The process of implementing a system for direction control and dynamic braking of a motor for an actuator of claim 18 wherein the actuation assembly comprises a clockwise braking circuit path comprising at least one diode configured to allow current to flow for dynamic braking of the motor from operation in a clockwise direction in response to the clockwise limit switch.

22. The process of implementing a system for direction control and dynamic braking of a motor for an actuator of claim 18 further comprising implementing a control assembly comprising a first switch and a second switch configured to selectively connect a direct current power supply to the actuation assembly, the motor, and the brake.

23. The process of implementing a system for direction control and dynamic braking of a motor for an actuator of claim 22 wherein the first switch and/or the second switch are implemented by a switch, a solenoid switch, a power switch, a power device, a transistor, and/or a power transistor.

24. The process of implementing a system for direction control and dynamic braking of a motor for an actuator of claim 22 wherein the first switch and/or the second switch are implemented by a switch, a solenoid switch, a power switch, a power device, a transistor, and/or a power transistor, and wherein the transistor and/or the power transistor are in a circuit path with an electromagnetic interference filter.

25. The process of implementing a system for direction control and dynamic braking of a motor for an actuator of claim 18 wherein the actuation assembly comprises at least one diode configured to allow current to flow for dynamic braking of the motor.

26. The process of implementing a system for direction control and dynamic braking of a motor for an actuator of claim 22 wherein the actuation assembly comprises a clockwise actuation circuit path for operating the motor in a clockwise direction.

27. The process of implementing a system for direction control and dynamic braking of a motor for an actuator of claim 26 wherein control assembly controls the first switch and the second switch to selectively connect the direct current power supply to the clockwise actuation circuit path for operating the motor in a clockwise direction.

28. The process of implementing a system for direction control and dynamic braking of a motor for an actuator of claim 26 wherein the actuation assembly comprises a clockwise braking circuit path comprising at least one diode configured to allow current to flow for dynamic braking of the motor from operation in the clockwise direction.

29. The process of implementing a system for direction control and dynamic braking of a motor for an actuator of claim 22 wherein the actuation assembly comprises a counterclockwise actuation circuit path for operating the motor in a counterclockwise direction.

30. The process of implementing a system for direction control and dynamic braking of a motor for an actuator of claim 29 wherein control assembly controls the first switch and the second switch to selectively connect the direct current power supply to the counterclockwise actuation circuit path for operating the motor in a counterclockwise direction.

31. The process of implementing a system for direction control and dynamic braking of a motor for an actuator of claim 29 wherein the actuation assembly comprises a counterclockwise braking circuit path comprising at least one diode configured to allow current to flow for dynamic braking of the motor from operation in the counterclockwise direction.

32. The process of implementing a system for direction control and dynamic braking of a motor for an actuator of claim 18 wherein the motor comprises a brushed direct current motor.

33. The process of implementing a system for direction control and dynamic braking of a motor for an actuator of claim 18 wherein the brake comprises a positive locking brake or a frictional brake.

34. The process of implementing a system for direction control and dynamic braking of a motor for an actuator of claim 18 wherein the brake comprises a pin brake/tooth brake.

35. A process of implementing a system for direction control and dynamic braking of a motor for an actuator, the system comprising:
configuring a motor to move an actuated component between a counterclockwise limit position and a clockwise limit position;
configuring a brake to hold an actuated component at the counterclockwise limit position or the clockwise limit position;
configuring an actuation assembly to operate the motor to move the actuated component between the counterclockwise limit position and the clockwise limit position;
configuring a counterclockwise limit switch to determine when the actuated component is at the counterclockwise limit position;
configuring a clockwise limit switch to determine when the actuated component is at the clockwise limit position;
configuring the actuation assembly to operate the motor to dynamically brake the actuated component in response to the clockwise limit switch or the counterclockwise limit switch;
configuring the actuation assembly to electrically absorb kinetic energy from the system to achieve dynamic braking; and
configuring the actuation assembly to operate the brake to be engaged thereby braking movement of the motor and/or the actuated component.
